(19) United States
(12) Patent Application Publication
(10) Pub. No.: US 2012/0210649 A1
(43) Pub. Date: Aug. 23, 2012

(54) System and Method of Protecting Flooring near a Doorway

(76) Inventor: Kenton Abel, Hacienda Heights, CA (US)

(21) Appl. No.: 13/403,636

(22) Filed: Feb. 23, 2012

Related U.S. Application Data
(60) Provisional application No. 61/446,030, filed on Feb. 23, 2011.

(51) Int. Cl. E06B 7/28

(52) U.S. Cl. 49/460; 49/506

(57) ABSTRACT

A system and method for protecting flooring near a doorway by securing to the bottom portion of the door a protective device where the protective device extends outward from the door and over the flooring where a pet may damage the flooring. The protective device is made of a scratch resistant material and the protective device is adapted to allow the door to open and remain securely attached to the door when open or closed.

This patent application claims priority pursuant to 35 U.S.C. §119(e) to U. S. Provisional Patent Application Ser. No. 61/446,030 filed Feb. 23, 2011, incorporated entirely by reference.

### BACKGROUND

For owners of indoor pets, one recurring problem is a pet's digging or scratching at the flooring near a closed door. This is common for carpet, but also includes other types of flooring. This is a problem for many types of indoor pets, including dogs, cats, ferrets, rabbits, etc.

Prior inventions protect a door from pet scratching. An example is U.S. Pat. No. 4,539,936 to Majewski, issued Sep. 10, 1985 and titled “Animal Door Scratch Preventer,” incorporated entirely by reference.

If a pet digs or scratches at the flooring or carpet near a doorway, the damage may be extensive enough to require replacement of the flooring or carpet in the entire room. This can easily cost hundreds of dollars and is disruptive to normal life during the replacement.

For dogs, the following is an example of the state of the art for stopping a dog from digging carpet and flooring at a doorway: 1) Fit your dog with both a leash and collar and getting your dog out for a walk. A long walk will get rid of excess energy and the dog once home will very likely settle down for a nap. If the dog is still exuberant, it may be necessary to walk your dog twice a day. 2) Shorten the dog's nails with the nail trimmer, as this will cause less damage in case the dog scratches the flooring and may reduce digging behaviors. If you feel uncomfortable doing this, a dog groomer or a vet's office will also trim nails for a fee. 3) Redirect any attempt to dig in the carpet using a toy. A sharp “No” or other loud sound should stop the dog in its tracks and then a toy should be offered as a reward for stopping. 4) Place the dog in the crate when the dog cannot be supervised. Many dogs know how to ignore the carpet when in the owner's presence, but will dig and scratch as soon as the owner leaves. Some dogs in particular, will scratch and dig at carpets because they become anxious when left alone.

For cats, suggestions for preventing damage to flooring includes placing carpet samples in front of the door or under the door, placing heavy plastic on the floor in front of the door, etc. Double-sided tape may be placed on the plastic to further deter the cat. One problem with these solutions is the cats eventually move the obstacle with the digging and then proceed to damage the flooring. Additionally, when the door is opened, the extra carpet or plastic is left on the floor and is both unsightly and a tripping hazard. If double-sided tape is on the plastic, there is the additional trouble of people accidentally stepping on the tape when they enter the room. There is a need for a improved way to protect the flooring near a doorway from pet damage.

The current invention helps protect the flooring near a doorway from pet damage, while avoiding the problems a tripping hazard or unsightly protective material on the floor at the doorway.

### FIGURES

FIG. 1 is a drawing of a doorway with one embodiment of a protective device of the present invention attached at the bottom of an open door.

FIG. 2 is a top view of one embodiment of a protective device of the present invention.

FIG. 3 is a drawing of a doorway with one embodiment of a protective device of the present invention attached at the bottom of a closed door.

### DESCRIPTION

In one embodiment, the present invention includes a method of protecting flooring near a doorway from pet damage by securing to the bottom portion of the door a protective device. The protective device extends outward from the door and over the flooring where a pet is scratching or digging. The protective device comprises a scratch resistant material and is adapted to allow a the doorway to open.

The door to be protected may be a standard indoor wooden door, an exterior door, a sliding door, etc. In a preferred embodiment, the protective device is attached on an interior side of a door.

In a preferred embodiment, the protective device is made of scratch resistant material. Examples include plastic, wood, metal, etc. In a more preferred embodiment, the protective device comprises plastic.

A protective device may be securely attached to the bottom portion of a door in a variety of ways. Examples include, but are not limited to, using glue, nails, screws, staples, clamps, etc. The protective device itself may be adapted to securely grip the bottom of the door without marring the look of the door. In one embodiment, the protective device is attached to the very bottom of the door using screws and/or nails, wherein the door may need to be removed from the hinges to attach the protective device. In another embodiment, the protective device is attached at the base of the door using a series of clamps without the need to remove the door from the hinges.

In yet another embodiment, the protective device is attached at the base on the opposite side of the door of the flooring to be protected using small nails, screws, tape, glue, etc., without the need to remove the door from the hinges. The protective device extends below the door and is attached using a small “L” portion to securely attach to the door.

In yet another embodiment, the protective device additionally contains a portion which extends up the front of the door to protect that from pet damage as well. This is especially important for pets such as small dogs which scratch at the door and dig at the flooring.

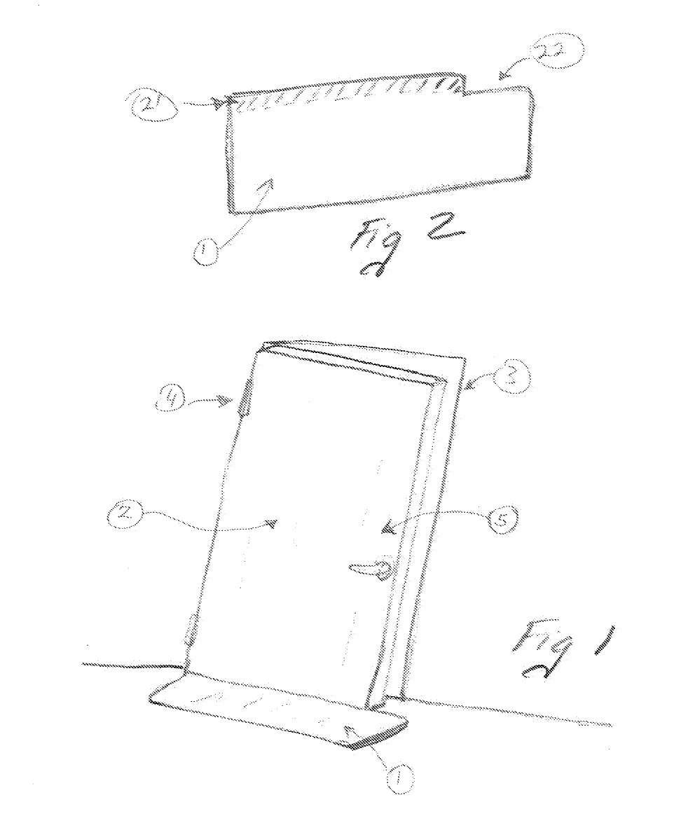

In reference to FIG. 1, Protective Device 1 is securely attached to the bottom of Door 2. In FIG. 1, Door 2 is open, and there is a space between Doorway 3 and the Handle Side 5 of Door 2. Hinges 4 secure Door 2 in Doorway 3. Protective Device 1 is adapted to move over the flooring when Door 2 swings on Hinges 4.

FIG. 2 shows a top view of one embodiment of Protective Device 1. Shaded portion 21 is adapted to fit securely on the bottom of a doorway. Area 22 is of Protective Device 1 is adapted to fit against a door frame and wall to prevent a pet from digging or scratching at the flooring where the door meets the doorway.

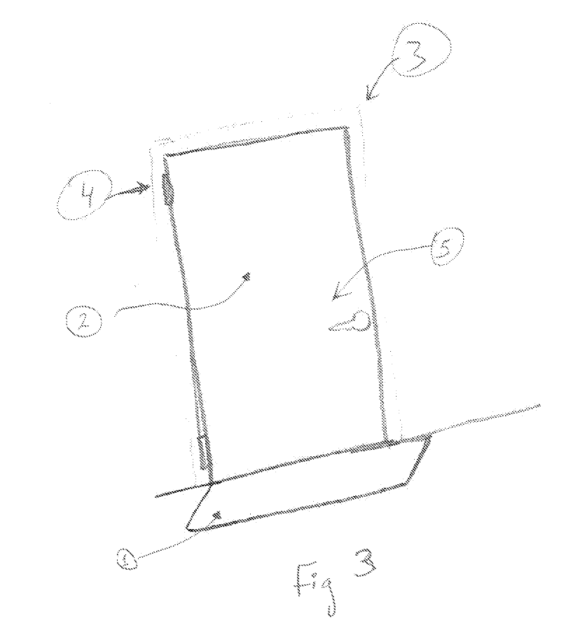

FIG. 3 shows Door 2 closed, with numbering the same as FIG. 1. Note that Protective Device 1 extends along the wall a sufficient distance protect the flooring where a pet is likely to dig or scratch.

### Example 1

A 16-year old grey and white male cat named Howard is confined to a bedroom so that other pets in the house do not eat his special diet. Howard digs at the carpet near the door in order to try to get out of the room when he is left alone. Carpet samples placed under the door and double folded are not effect in protecting the room carpet as Howard digs with enough strength to pull the carpet samples into the room.

To protect the carpet, the door to the room is taken off the hinges. A protective device made of plastic several millimeters thick was securely attached to the bottom of the door using small screws every four inches. The protective device was cut to be flush with the doorway frame and wall when the door was closed. The protective device extended over the carpet for about three inches. The door was then returned to the hang on the hinges, and the carpet samples were removed. The door could easily swing on the hinges, and the protection device was out of sight when the door was completely open.

Howard continued to dig and scratch at the base of the door when left alone and the door was closed. The protection device prevented the room carpet from any additional damage.

1) A method of protecting flooring near a doorway from pet damage comprising:
securing to the bottom portion of the door a protective device,
wherein the protective device extends outward from the door and over the flooring where a pet may damage the flooring;
wherein the protective device comprises a scratch resistant material; and,
wherein the protective device is adapted to allow the door to open and remain securely attached to the door when open or closed.

2) The method of claim 1, wherein the protective device comprises plastic.

3) The method of claim 1, wherein the protective device is shaped to extend past the end of the door and along the wall for several inches.

4) The method of claim 1, wherein the protective device further comprises a sticky top surface.

5) A system for protecting flooring near a doorway comprising:
a protective device securely attached to the bottom portion of the door,
wherein the protective device extends outward from the door and over the flooring where a pet may damage the flooring;
wherein the protective device comprises a scratch resistant material; and,
wherein the protective device is adapted to allow the door to open and still remain securely attached to the door when open or closed.

6) The system of claim 4, wherein the protective device comprises plastic.

7) The system of claim 4, wherein the protective device is shaped to extend past the end of the door and along the wall for several inches.

8) The system of claim 4, wherein the protective device further comprises a sticky top surface.
